(19) United States
(12) Patent Application Publication
(10) Pub. No.: US 2015/0159762 A1
(43) Pub. Date: Jun. 11, 2015

(54) SEAL ASSEMBLY

(71) Applicant: GM GLOBAL TECHNOLOGY OPERATIONS LLC, Detroit, MI (US)

(72) Inventors: Todd E. Allen, Lake Orion, MI (US); Seung H. Lee, Troy, MI (US)

(73) Assignee: GM GLOBAL TECHNOLOGY OPERATIONS LLC, Detroit, MI (US)

(21) Appl. No.: 14/097,309

(22) Filed: Dec. 5, 2013

(51) Int. Cl. F16J 15/52

(52) U.S. Cl. CPC F16J 15/52

(57) ABSTRACT

A seal assembly includes a first spring portion and a second spring portion. The first spring portion extends along a central axis, between a lower axial end and an upper axial end. A plate is attached to the upper axial end of the first spring portion. The second spring portion extends along the central axis, between a first axial end and a second axial end. The plate is attached to the first axial end of the second spring portion. The first spring portion defines a first spring constant, and the second spring portion defines a second spring constant. The first spring constant is greater than the second spring constant. The first spring portion includes a first permanent set value, and the second spring portion includes a second permanent set value. The first permanent set value is less than the second permanent set value.

### TECHNICAL FIELD

The invention generally relates to a seal assembly, and more specifically to a seal assembly for sealing around a steering shaft, between a pinion housing of a steering gear and an engine compartment bulkhead of a vehicle.

### BACKGROUND

A steering shaft links a steering gear to a steering wheel of a vehicle. The steering wheel is disposed within a passenger compartment of the vehicle. The steering gear is disposed within an engine compartment of the vehicle. A bulkhead (separates the passenger compartment from the engine compartment. Accordingly, the steering shaft must pass through the bulkhead to connect the steering wheel with the steering gear. The bulkhead is provided with an opening to allow the steering shaft to pass through the bulkhead. A dust cover or seal assembly is disposed around the steering shaft to seal the opening in the bulkhead. The seal operates to prevent water, noise, dust, air and debris from entering the passenger compartment through the opening in the bulkhead.

### SUMMARY

A seal assembly for sealing around a steering shaft of a vehicle is provided. The seal assembly includes a first spring portion and a second spring portion. The first spring portion extends along a central axis, between a lower axial end and an upper axial end. The lower axial end of the first spring portion is configured for sealing against a rigid structure. A plate is attached to the upper axial end of the first spring portion. The second spring portion extends along the central axis, between a first axial end and a second axial end. The plate is attached to the first axial end of the second spring portion. The second axial end of the second spring portion is configured for sealing against a bulkhead of the vehicle. Each of the first spring portion and the second spring portion include a compression spring. The first spring portion defines a first spring constant, and the second spring portion defines a second spring constant. The first spring constant is greater than the second spring constant. The first spring portion includes a first permanent set value, and the second spring portion includes a second permanent set value. The first permanent set value is less than the second permanent set value.

Accordingly, the first spring portion and the second spring portion are aligned in series, with the plate disposed therebetween transferring spring forces between the first spring portion and the second spring portion. The second spring portion seals against a bulkhead of a vehicle, around an opening in the bulkhead allowing a steering shaft to pass through the bulkhead. The seal assembly is compressed between the bulkhead, and a rigid structure, such as a pinion housing of a steering gear. The first spring portion, having a higher spring constant, operates to compress the second spring portion, having a lower spring constant, over a larger area. This allows the second spring portion to seal against a larger area than the first spring portion, and provides more freedom to accommodate build variations, while maintaining a quality seal around the opening in the bulkhead.

The above features and advantages and other features and advantages of the present invention are readily apparent from the following detailed description of the best modes for carrying out the invention when taken in connection with the accompanying drawings.

### BRIEF DESCRIPTION OF THE DRAWINGS

FIG. 1 is a schematic perspective cross sectional view of a seal assembly.

FIG. 2 is a schematic cross sectional view of the seal assembly.

FIG. 3 is a schematic plan view of the seal assembly.

FIG. 4 is a schematic perspective cross sectional view of a second embodiment of the seal assembly.

### DETAILED DESCRIPTION

Those having ordinary skill in the art will recognize that terms such as “above,” “below,” “upward,” “downward,” “top,” “bottom,” etc., are used descriptively for the figures, and do not represent limitations on the scope of the invention, as defined by the appended claims. Furthermore, the invention may be described herein in terms of functional and/or logical block components and/or various processing steps. It should be realized that such block components may be comprised of any number of hardware, software, and/or firmware components configured to perform the specified functions.

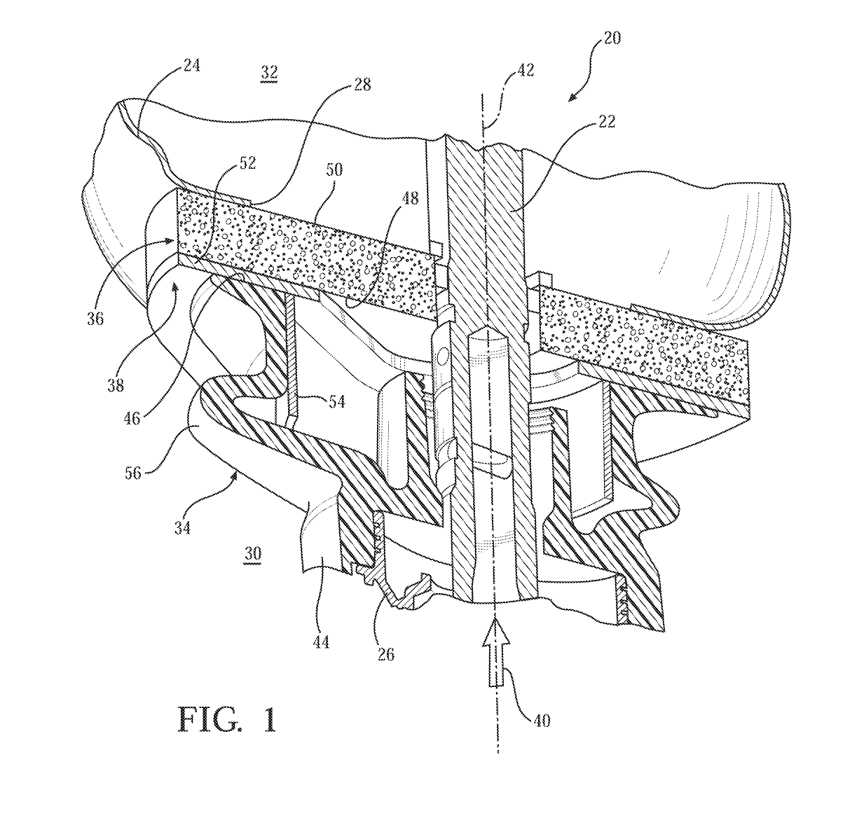

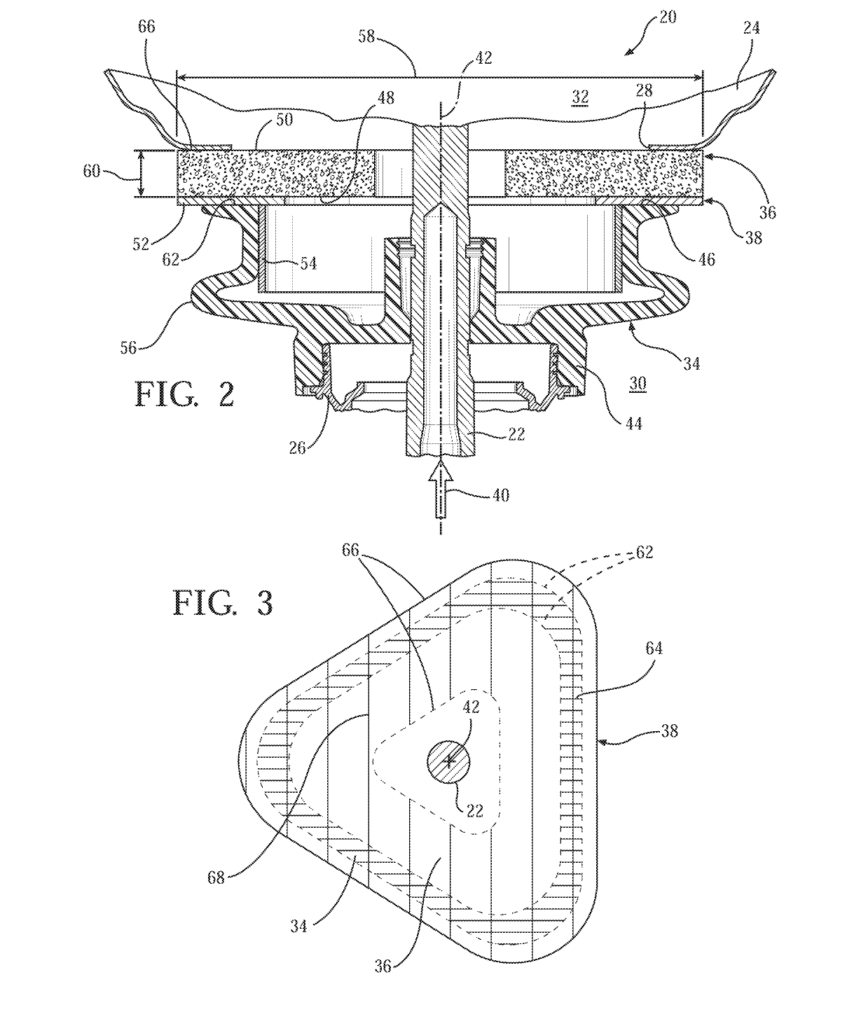

Referring to the Figures, wherein like numerals indicate like parts throughout the several views, a seal assembly is generally shown at 20. Referring to FIGS. 1 and 2, the seal assembly 20 seals around a steering shaft 22, between a bulkhead 24 of a vehicle and a rigid structure 26, such as but not limited to a pinion housing of a steering gear. The bulkhead 24 of the vehicle defines an opening 28, through which the steering shaft 22 extends. The seal assembly 20 seals the opening 28, to prevent water, dirt, air, dust, debris, and noise from passing from an engine compartment 30 of the vehicle, through the opening 28 in the bulkhead 24, and into a passenger compartment 32 of the vehicle.

The seal assembly 20 includes a first spring portion 34, a second spring portion 36, and a plate 38 disposed between and interconnecting the first spring portion 34 and the second spring portion 36. Each of the first spring portion 34 and the second spring portion 36 include and/or are formed to define or create a compression spring. It should be understood that compression springs are designed to operate under a compression load 40, generally indicated in FIG. 2 by force arrow 40. Compression springs get shorter as the compression load 40 is applied, with a spring force generated by the compression spring resisting the compression load 40, and compression of the spring. The first compression spring and the second compression spring are compressed between the bulkhead 24 and the rigid structure 26.

The first spring portion 34 extends along a central axis 42, between a lower axial end 44 and an upper axial end 46. The second spring portion 36 extends along the central axis 42, between a first axial end 48 and a second axial end 50. Preferably, each of the first spring portion 34 and the second spring portion 36 are bonded to a planar portion 52 of the plate 38 with an adhesive, or some other bonding agent. The plate 38 is attached to the upper axial end 46 of the first spring portion 34, and is attached to the first axial end 48 of the second spring portion 36. The plate 38 is operable to transmit axial forces, directed along the central axis 42, between the first spring portion 34 and the second spring portion 36.

The lower axial end 44 of the first spring portion 34 is configured for sealing against the rigid structure 26. The second axial end 50 of the second spring portion 36 is configured for sealing against the bulkhead 24. The seal assembly 20 is compressed between the bulkhead 24 and the rigid structure 26, thereby applying the compression load 40 to the seal assembly 20, against which both the first spring portion 34 and the second spring portion 36 react.

As noted above, the plate 38 includes a planar portion 52. The planar portion 52 is disposed transverse to the central axis 42, and defines an annular ring that extends around and encircles the central axis 42. The plate 38 further includes a cylindrical portion 54, which extends along the central axis 42. The cylindrical portion 54 is substantially perpendicular to the planar portion 52, and extends around and encircles the central axis 42. The first spring portion 34 is at least partially disposed radially outside of the cylindrical portion 54 of the plate 38, relative to the central axis 42 and adjacent the upper axial end 46 of the first spring portion 34. Accordingly, the cylindrical portion 54 radially supports at least a portion of the first spring portion 34.

The first spring portion 34 includes at least one annular accordion structure 56 disposed between the lower axial end 44 and the upper axial end 46 of the first spring portion 34. The accordion structure 56 may be described as a bellows, or other similar construction. Compression of the accordion structure 56, under the compression load 40, generates the spring force of the first spring portion 34, which is applied to the second spring portion 36 via the plate 38.

As shown in FIG. 2, the second spring portion 36 defines a planar, annular ring, which extends around and encircles the central axis 42. The second spring portion 36 includes an uncompressed width 58 measured transverse to the central axis 42, and an uncompressed height 60 measured substantially parallel with the central axis 42. It should be appreciated that the width 58 and height 60 of the second spring portion 36 will vary under the compression load 40, as the second spring portion 36 is compressed.

Referring to FIG. 3, the upper axial end 46 of the first spring portion 34 defines a first contact surface 62 having a first area 64, when compressed under the compression load 40. The first area 64 is the circumferential area of the first contact surface 62, measured substantially perpendicular to the central axis 42. The second axial end 50 of the second spring portion 36 defines a second contact surface 66 having a second area 68, when compressed under the compression load 40. The second area 68 is the circumferential area of the second contact surface 66, measured substantially perpendicular to the central axis 42. The second area 68 of the second contact surface 66 is greater than the first area 64 of the first contact surface 62. Accordingly, the second contact surface 66 spreads the compression load 40 over a larger area than the first contact surface 62. The first spring portion 34 and the second spring portion 36 are arranged in series, and use the plate 38 to transfer the compression load 40 from the smaller first area 64 of the first contact surface 62, to the larger second area 68 of the second contact surface 66. The larger second area 68 of the second contact surface 66 accommodates variation in the location of the opening 28 in the bulkhead 24, due to assembly variance.

The first spring portion 34 may include and be manufactured from, but is not limited to, a rubber material. Preferably, the material used to manufacture the first spring portion 34 may include a Shore A Durometer greater than 40, by way of a non-limiting example. The second spring portion 36 may include and be manufactured from, but is not limited to, one of a rubber material or a foam material. The material used to manufacture the second spring portion 36 may include a Shore A Durometer less than 20, by way of a non-limiting example.

The first spring portion 34 defines a first spring constant, and the second spring portion 36 defines a second spring constant. As is known, a spring constant is defined as the force applied to the spring divided by the distance the spring moves from its original free length, i.e., uncompressed length. The first spring constant of the first spring portion 34 is greater than the second spring constant of the second spring portion 36. Preferably, the first spring constant is between the range of 30 N/mm and 50 N/mm, and the second spring constant is less than 1.0 N/mm, by way of a non-limiting example. However, it should be appreciated that the first spring constant and the second spring constant may vary from the exemplary ranges provided herein.

A permanent set occurs when a spring is deflected beyond its elastic properties, and does not return to its original free length. Because of the physical properties of the first spring portion 34 and the second spring portion 36, any permanent set that occurs in the second spring portion 36 is consumed, i.e., compensated for, by the first spring portion 34. As such, any loss in elasticity in the second spring portion 36, is compensated for by the first spring portion 34.

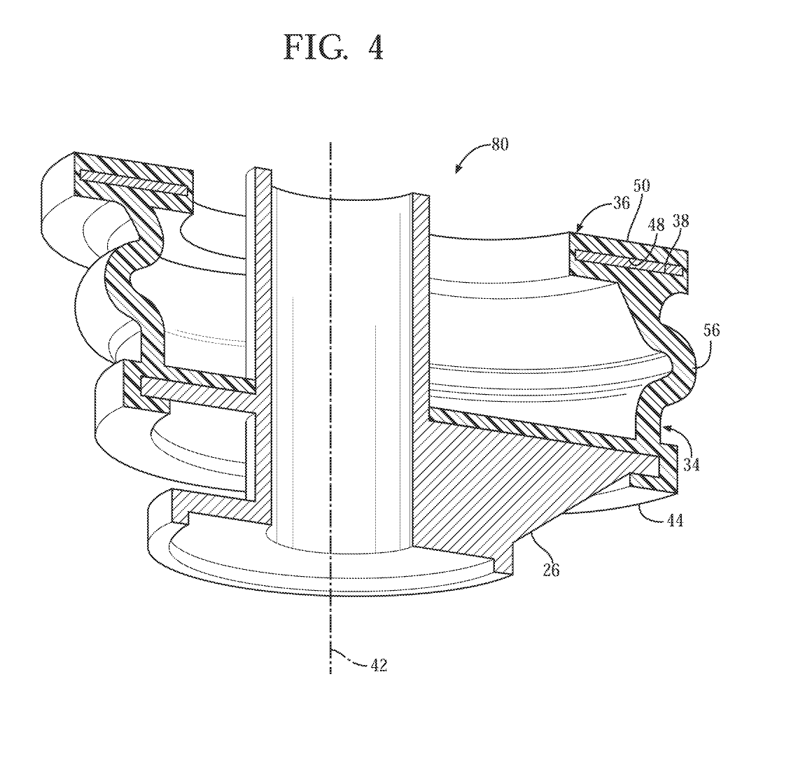

Referring to FIG. 4, a second embodiment of the seal assembly is generally shown at 80. The seal assembly 80 is shown in an uncompressed state, i.e., without the compression load 40 applied. The seal assembly 80 operates in the same manner as the seal assembly 20, shown in FIGS. 1 and 2. The seal assembly 80 differs from the seal assembly 20 in that the plate 38 is over molded, such as with a rubber or similar material. The first spring portion 34 is disposed below the plate 38 when viewed on the page of FIG. 4, and the second spring portion 36 is disposed above the plate 38 when viewed on the page of FIG. 4. The first spring portion 34 of the seal assembly 80 may include a higher stiffness than the second spring portion 36 of the seal assembly 80. However, any permanent set that occurs in the second spring portion 36 is still consumed, i.e., compensated for, by the first spring portion 34.

The detailed description and the drawings or figures are supportive and descriptive of the invention, but the scope of the invention is defined solely by the claims. While some of the best modes and other embodiments for carrying out the claimed invention have been described in detail, various alternative designs and embodiments exist for practicing the invention defined in the appended claims.

1. A seal assembly for sealing around a steering shaft, between a bulkhead of a vehicle and a steering gear pinion housing, the seal assembly comprising:
a first spring portion extending along a central axis, between a lower axial end and an upper axial end;
a plate attached to the upper axial end of the first spring portion; and
a second spring portion extending along the central axis, between a first axial end and a second axial end, wherein the plate is attached to the first axial end of the second spring portion.

2. The seal assembly set forth in claim 1 wherein the first spring portion defines a first spring constant, and the second spring portion defines a second spring constant, with the first spring constant being greater than the second spring constant.

3. The seal assembly set forth in claim 2 wherein the first spring constant is between 30 N/mm and 50 N/mm, and wherein the second spring constant is less than 1.0 N/mm

4. The seal assembly set forth in claim 1 wherein the first spring portion includes a first permanent set value, and the second spring portion includes a second permanent set value, with the first permanent set value being less than the second permanent set value.

5. The seal assembly set forth in claim 4 wherein the first spring portion is operable to compensate for any permanent set in the second spring portion.

6. The seal assembly set forth in claim 1 wherein the upper axial end of the first spring portion defines a first contact surface having a first area, and the second axial end of the second spring portion defines a second contact surface having a second area, with the second area of the second contact surface being greater than the first area of the first contact surface.

7. The seal assembly set forth in claim 1 wherein each of the first spring portion and the second spring portion include a compression spring.

8. The seal assembly set forth in claim 1 wherein the first spring portion includes and is manufactured from a rubber material having a Shore A Durometer greater than 40.

9. The seal assembly set forth in claim 1 wherein the second spring portion includes and is manufactured from one of a rubber material or a foam material, having a Shore A Durometer less than 20.

10. The seal assembly set forth in claim 1 wherein the plate includes a planar portion disposed transverse to the central axis, and a cylindrical portion extending along the central axis, wherein the cylindrical portion is substantially perpendicular to the planar portion.

11. The seal assembly as set forth in claim 10 wherein the first spring portion is at least partially disposed radially outside of the cylindrical portion of the plate, relative to the central axis and adjacent the upper axial end of the first spring portion, such that the cylindrical portion radially supports at least a portion of the first spring portion.

12. The seal assembly as set forth in claim 11 wherein the first spring portion includes at least one annular accordion structure disposed between the lower axial end and the upper axial end of the first spring portion, wherein compression of the at least one accordion structure generates a spring force of the first spring portion.

13. The seal assembly set forth in claim 10 wherein each of the first spring portion and the second spring portion are bonded to the planar portion of the plate with an adhesive.

14. A seal assembly for sealing around a steering shaft, the seal assembly comprising:
a first spring portion extending along a central axis, between a lower axial end and an upper axial end, wherein the lower axial end of the first spring portion is configured for sealing against a rigid structure;
a plate attached to the upper axial end of the first spring portion;
a second spring portion extending along the central axis, between a first axial end and a second axial end, wherein the plate is attached to the first axial end of the second spring portion, and wherein the second axial end of the second spring portion is configured for sealing against a bulkhead;
wherein each of the first spring portion and the second spring portion includes a compression spring;
wherein the first spring portion defines a first spring constant, and the second spring portion defines a second spring constant, with the first spring constant being greater than the second spring constant; and
wherein the first spring portion includes a first permanent set value, and the second spring portion includes a second permanent set value, with the first permanent set value being less than the second permanent set value.

15. The seal assembly set forth in claim 14 wherein the first spring constant is between 30 N/mm and 50 N/mm, and wherein the second spring constant is less than 1.0 N/mm

16. The seal assembly set forth in claim 14 wherein the first spring portion is operable to compensate for any permanent set in the second spring portion.

17. The seal assembly set forth in claim 14 wherein the upper axial end of the first spring portion defines a first contact surface having a first area, and the second axial end of the second spring portion defines a second contact surface having a second area, with the second area of the second contact surface being greater than the first area of the first contact surface.

18. The seal assembly set forth in claim 14 wherein the plate includes a planar portion disposed transverse to the central axis, and a cylindrical portion extending along the central axis, wherein the cylindrical portion is substantially perpendicular to the planar portion.

19. The seal assembly as set forth in claim 18 wherein the first spring portion is at least partially disposed radially outside of the cylindrical portion of the plate, relative to the central axis and adjacent the upper axial end of the first spring portion, such that the cylindrical portion radially supports at least a portion of the first spring portion.

20. The seal assembly as set forth in claim 19 wherein the first spring portion includes at least one annular accordion structure disposed between the lower axial end and the upper axial end of the first spring portion, wherein compression of the at least one accordion structure generates a spring force of the first spring portion.
